(19) United States
(12) Patent Application Publication
(10) Pub. No.: US 2021/0220205 A1
(43) Pub. Date: Jul. 22, 2021

(54) KNEE CONTINUOUS PASSIVE MACHINE AND METHOD

(71) Applicant: CONG THANH DIEP TU, HO CHI MINH (VN)

(72) Inventor: CONG THANH DIEP TU, HO CHI MINH (VN)

(73) Assignee: TON DUC THANG UNIVERSITY, HO CHI MINH (VN)

(21) Appl. No.: 15/055,519

(22) Filed: Feb. 26, 2016

(51) Int. Cl. A61H 1/02

(52) U.S. Cl. CPC A61H 1/024; A61H 2201/5069; A61H 2201/5061

(57) ABSTRACT

A knee continuous passive machine (CPM) device and method are disclosed which includes a base, a foldable leg frame assembly, a manual mode assembly, a pneumatic artificial muscle (PAM) motor, a system of pulleys, a force sensor, and an angle sensor. The manual mode assembly is designed to find a comfort zone for each patient and then a computer system updates each patient's comfort zone into a database and controls the PAM motor to provide rehabilitating exercises for each patient without risk of injuries.

### FIELD OF THE INVENTION

The present invention relates generally to the field of medical devices. More specifically, the present invention relates to a rehabilitating device that assists a patient to recover the knee functions.

### BACKGROUND ART

Continuous passive motion (CPM) is a way of providing exercises for a knee joint using a machine. This machine flexes the knee joint through a range of motion to help patients rehabilitate and recover from surgeries or other treatments of the knee joint. Initially such machines were very large and cumbersome, and they were typically attached to a bed or integrated with the patient bed in a manner that prevented portability of the therapy device. More recently unitary but otherwise portable devices have been introduced to provide a compact CPM machine to provide CPM therapy outside the hospital setting.

The application of continuous passive motion (CPM) to a joint following a period of immobilization, injury, surgery or the like, has been shown to reduce post-operative pain, decrease the number of adhesions, decrease the amount of atrophy experienced by the surrounding and supporting muscle, promote the speed of recovery, improve the range of motion in a much shorter time, and reduce the risk of deep vein thrombosis. Depending on the nature and severity of the injury or the nature and extent of the surgical procedure performed, therapeutic treatment sessions involving continuous passive motion may be carried out on a daily basis for several days or several weeks.

The therapeutic use of an external force to flex and extend the limb to induce motion is referred to as passive motion. The application of continuous passive motion to a joint following a period of immobilization, injury, surgery or the like, has been shown to reduce post-operative pain, decrease the number of adhesions, decrease the amount of atrophy experienced by the surrounding and supporting muscle, promote the speed of recovery, improve the range of motion in a much shorter time, and reduce the risk of deep vein thrombosis and post-traumatic osteopenia. Depending on the nature and severity of the knee injury or the nature and extent of the surgical procedure performed, therapeutic treatment sessions involving continuous passive motion may be carried out on a daily basis for several days or several weeks.

There have been a number of developments and improvements in the knee CPM technology. Despite these improvements in CPM technology, conventional CPM devices suffer from several disadvantages. Among these is the fact that conventional CPM machines do not generally provide a mechanism for relieving or avoiding pain or sensitivity that a patient may experience when his knee is being flexed or his leg extended in a direction or to a point or angle which is uncomfortable. While some CPM machines automatically turn themselves off when a preset level of resistance is encountered during operation, many knee CPM machines are not sensitive or responsive to resistance encountered during operation and continue flexion and extension to the preset limits until turned off.

Although a few CPM machines stop and/or reverse the direction of the driver and carriage when signaled by the patient or when a preset level of resistance is encountered, those same machines attempt to return the carriage to the preset flexion or extension limit on the next cycle, thereby, subjecting the patient to a risk that he or she will encounter the same discomfort or perhaps injury.

Other knee CPM machines include a comfort zone range of motion feature which allows an operator to temporarily increase or decrease the flexion angle to alleviate discomfort the patient is subject to. However, when the patient feels the pains or discomfort, it may be too late to avoid debilitating injury to the patient's knee.

Therefore what is needed is a knee CPM machine that can find and update the comfort zone of each patient where there is no risk of comfort and or injury.

### SUMMARY OF THE INVENTION

Accordingly, an objective of the present invention is to provide a knee continuous passive machine (CPM) which provides solutions to the problems described above. Thus, a knee continuous passive machine (CPM) device and method are disclosed which includes a base, a foldable leg frame assembly, a manual mode assembly, a pneumatic artificial muscle (PAM) motor, a system of pulleys, a force sensor, and an angle sensor. The manual mode assembly is designed to find a comfort zone for each patient and then a computer system updates each patient's comfort zone into a database and controls the PAM motor to provide rehabilitating exercises for each patient without risk of injuries.

These and other advantages of the present invention will no doubt become obvious to those of ordinary skill in the art after having read the following detailed description of the preferred embodiments, which are illustrated in the various drawing Figures.

### BRIEF DESCRIPTION OF THE DRAWINGS

The accompanying drawings, which are incorporated in and form a part of this specification, illustrate embodiments of the invention and, together with the description, serve to explain the principles of the invention.

FIG. 1 is a diagram illustrating a plain view of a knee continuous passive machine (CPM) in a stretched out position in accordance with an embodiment of the present invention;

FIG. 2 is a diagram illustrating a plain view of a knee continuous passive machine (CPM) in a flex position in accordance with an embodiment of the present invention;

FIG. 3 is a diagram illustrating the structure of the manual mode assembly of the knee CPM of FIG. 1 in accordance with an embodiment of the present invention;

FIG. 4 is a diagram illustrating the arrangements of the first pulley system and a second pulley system in accordance with an embodiment of the present invention;

FIG. 5. is a diagram illustrating spatial arrangements of the manual mode assembly, the pneumatic artificial muscle (PAM), the first pulley system, and the second pulley system on the base in accordance with an embodiment of the present invention;

FIG. 6 is a diagram illustrating the lateral view of the knee CPM in the flex position in accordance with an embodiment of the present invention;

FIG. 7 is a diagram illustrating the use of the knee CPM in accordance with an embodiment of the present invention;

FIG. 8 is a diagram illustrating the knee CPM in accordance with an embodiment of the present invention;

FIG. 9 is a schematic diagram illustrating a control system of the knee CPM in accordance with an embodiment of the present invention; and

FIG. 10 is a flow chart illustrating the method of use of the knee CPM in accordance with an embodiment of the present invention.

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail so as not to unnecessarily obscure aspects of the present invention.

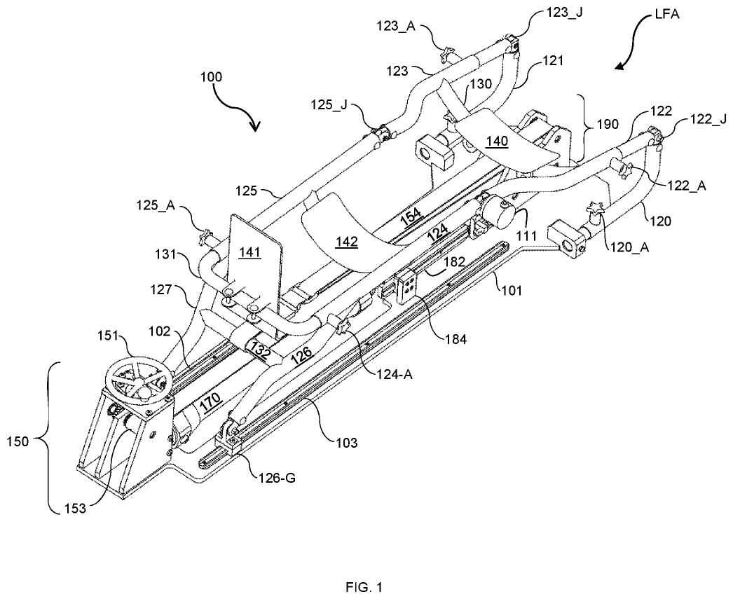

One embodiment of the invention is now described with reference to FIG. 1 to FIG. 9. FIG. 1 shows an embodiment of a knee continuous passive machine 100 (hereinafter referred to as ‘knee CPM 100’). Knee CPM 100 includes a base 101 having a first track 102 and a second track 103 located along the left hand side and the right hand side of base 101 respectively. On the top side of base 101, a foldable leg frame assembly LFA having a first segment 120 and a second segment 121 fixedly connected to the back side of base 101. An eight segment 126 and the ninth segment 127 of foldable leg frame assembly LFA are movably coupled to first track 102 and second track 103. In this embodiment, first segment 120 and second segment 121 serve as hind legs while eight segment 126 and night segment 127 serve as front legs of leg frame assembly LFA. A tenth segment 132 connects eighth segment 126 and ninth segment 127.

Continuing with the discussion of FIG. 1, foldable leg frame assembly LFA further includes a third segment 122 connected to a first segment 120 at a first rotatable joint 122_J, a fourth segment 123 connected to second segment 121 at a second rotatable joint 123_J. Similarly, a fifth segment 124 is connected to third segment 122 at a third rotatable joint 124_J. Finally, a sixth segment 125 is connected to fourth segment 123 at a fourth rotatable joint 125_J. In one embodiment, an angle sensor 111 is connected to third rotatable joint 124_J along the knee pivot axis to measure the angle from which foldable leg assembly LGA is folded at third rotatable joint 124_J and fourth rotatable joint 125_J. A seventh segment 131 jointly connects fifth segment 124 and sixth segment 125 together. In one embodiment, first segment 120, second segment 121, third segment 122, fourth segment 123, fifth segment 124, and sixth segment 125 all are made from telescoping tubes designed to telescopically adjust their length by clevis pins 120_A, 121_A, 122_A, 123_A, 124_A, and 125_A respectively.

Still referring to FIG. 1, eighth segment 125 is equipped with a first square C shaped connector 125_G slidably coupled to slide along the length of first track 102. Similarly, ninth segment 126 is equipped with a second square C shaped connector 126_G slidably coupled to slide along the length of second track 103. With such structure, foldable leg frame assembly LGA is foldable along the knee axis at third joint 124_J and fourth joint 125_J as first square C shaped connector 125_G and second square C shaped connector 126_G slide along the length of first track 102 and second track 103 respectively.

Still referring to FIG. 1, foldable leg frame assembly LFA also has a femoral support member 140 connected between third segment 122 and fourth segment 123, a tibial support member 142 connected between fifth segment 124 and sixth segment 125, and a foot rest 141 connected perpendicular to seventh segment 131. In one embodiment, femoral support member 140 is a concave rectangular plate connected in perpendicular to third segment 122 and fourth segment 123 so that a user can comfortably rest his or her thigh. Similarly, tibial support member 142 is a concave rectangular plate connected In perpendicular to fifth segment 124 and sixth segment 125 so that a user can comfortably rest his or her calf thereto.

Still referring to FIG. 1, knee CPM 100 also includes pulley system 190, a pneumatic artificial muscle (PAM) 170, and a manual mode structure 150, all connected together in series in a straight line between first track 102 and second track 103. The detailed descriptions of these elements will be discussed in the following figures.

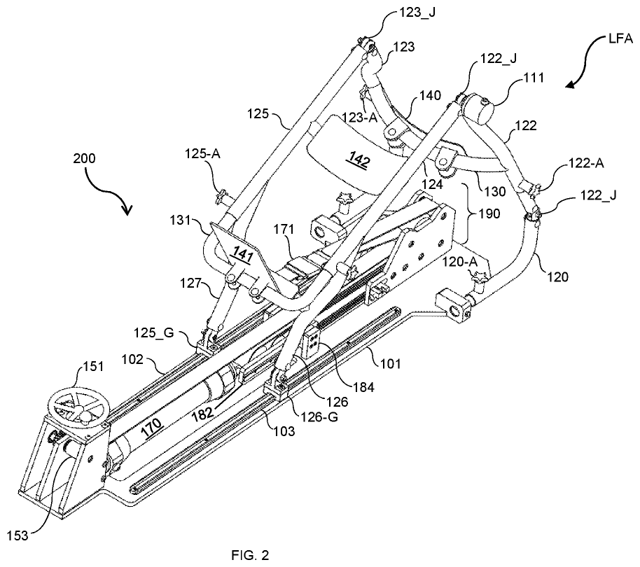

Next referring to FIG. 2 which illustrates a perspective view 200 of knee CPM 100 when flexed along a user's knee pivot axis. In perspective view 200, PAM 170 is connected between pulley system 190 and manual mode structure 150. In one embodiment, PAM 170 is MAS-40-N-300-AA-MCFK manufactured by Festo with a diameter of 40 mm and length of 300 mm. This type of PAM has a maximum operating force of 6000 N and permissible contraction of 25%.

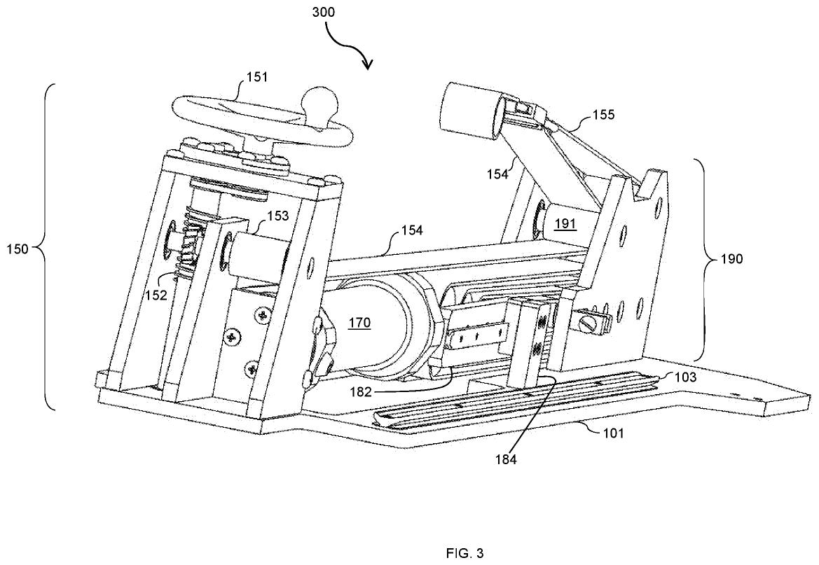

Now referring to FIG. 3 which illustrates a perspective view 300 of knee CPM 100 with leg frame assembly LFA removed to show the inner structure of manual mode structure 150. Manual mode structure 150 has a crank wheel 151 connected to a worm gear 152 and a pulley 153. Pulley 153 is connected to leg frame assembly LFA by a first cable 154 via a pulley 191.

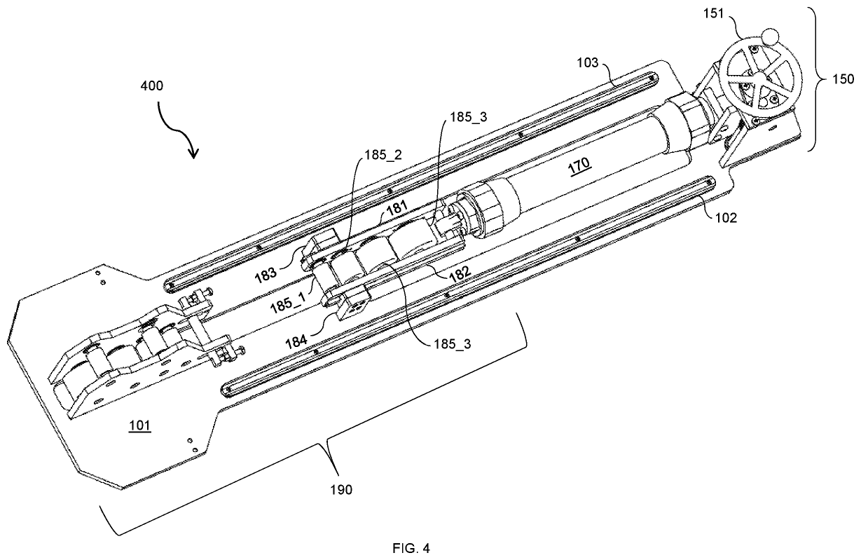

Next referring to FIG. 4 which illustrates a top view 400 of knee CPM 100 with leg frame assembly LFA removed to show the structure of pulley system 190. In one embodiment as shown in FIG. 4, pulley system 190 further includes a first pulley system 185. First pulley system 185 includes pulley 185_1, 185_2, 185_3, and 185_4 connected in series. In the preferred embodiment, first pulley system 185 has a variable radius with pulley 185_1 having the smallest radius and pulley 185_4 having the largest radius. FIG. 4 also illustrates the connections of PAM 170 to pulley system 190. In an exemplary embodiment, at one end, PAM 170 is fixedly connected to knee CPM 100 at manual mode structure 150. At the other end of PAM 170 connected to a first frame 181 and a second frame 182 of first pulley system 185. First frame 181 and second frame 182 are slidably connected to a first connector 183 and a second connector 184.

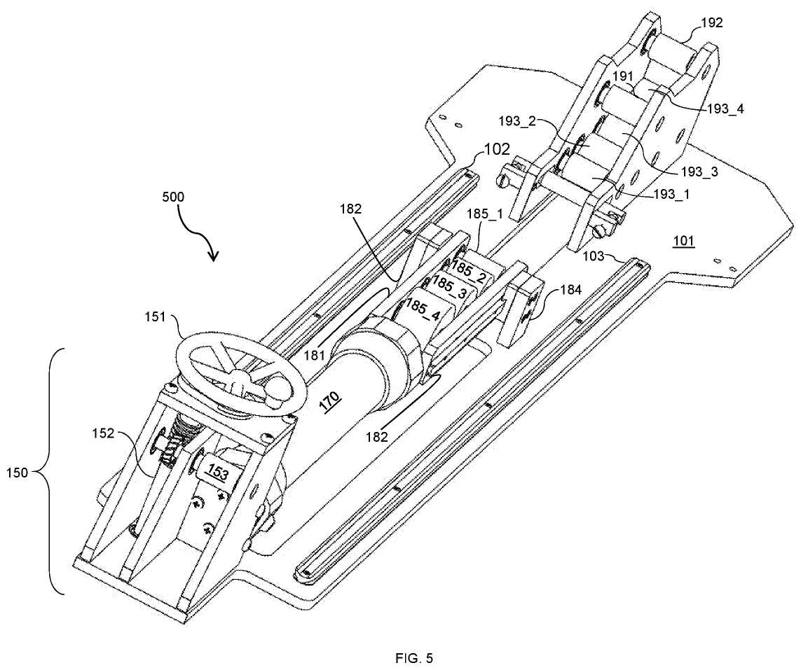

Next referring to FIG. 5 which illustrates a perspective view 500 of knee CPM 100 with leg frame assembly LFA removed. In perspective view 500, pulley system 190 also includes a second pulley system 193 which is comprised of pulley 193_1, 193_2, 193_3, and 193_4 connected in series. In the preferred embodiment, second pulley system 193 has a variable radius with pulley 193_1 having the smallest radius and pulley 193_4 having the largest radius.

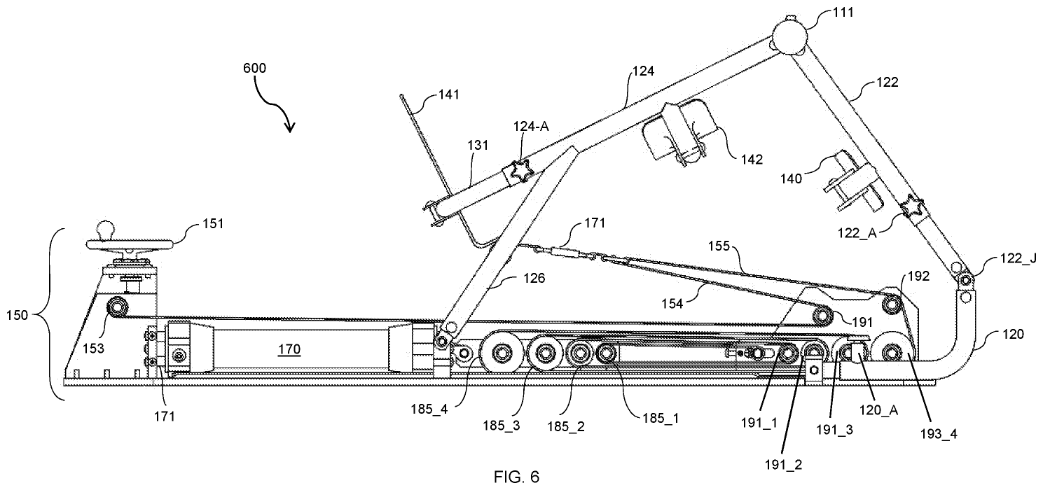

Next referring to FIG. 6, a lateral view 600 of knee CPM 100 is illustrated. Lateral view 600 illustrates two major connections of knee CPM 100. The first connection is between manual mode structure 150 to knee CPM 100 via first cable 154. The second connection is between first pulley system 185, second pulley system 193, and leg frame assembly LFA via a second cable 155. More specifically, in the first connection, first cable 154 connects pulley 153 to pulley 191 and to leg frame assembly LFA via a hook. The second connection is more complex, second cable 155 starts from a fixed connector in second pulley system 193 and wraps around pulley 185_1. Then, second cable 155 goes back wrapping around pulley 193_1, then pulleys 185_2, 193_2, 185_3, 193_3, 185_4, and 193_4 in that order. As such, first pulley system 185 and second pulley system 193 serve as a force amplification for PAM 170. A force sensor 171 is connected between LFA and first cable 154 and second cable 155 so that force sensor 171 senses the tensions of first cable 154 and second cable 155 separately. More particularly, one end of force sensor 171 is connected to tenth segment 132. The other end of force sensor 171 is connected to the common node of first cable 154 and second cable 155.

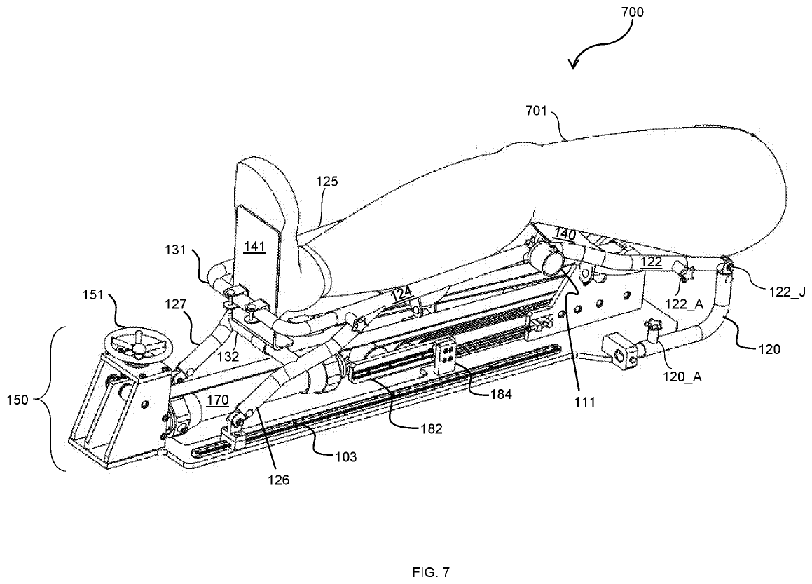

Next referring to both FIG. 7 which illustrates the operation of knee CPM 100 when the user's knee is fully extended. In FIG. 7, a perspective view 700 showing knee CPM 100 in use by a user 701. At first, user 701 places his/her leg onto knee CPM 100. Then the length of leg frame assembly LFA is adjusted using pins 120_A, 121_A, 122_A, 123_A, 124_A, and 125_A. Next, manual mode structure 150 is used to find a comfortable force and angle for user 701. In manual mode structure 150, crank wheel 151 is rotated causing worm gear 153 to turn pulley 191. As crank wheel 153 is rotated, leg frame assembly LFA reciprocates by sliding on first track 102 and second track 103. As a result, LFA extends as shown in FIG. 7.

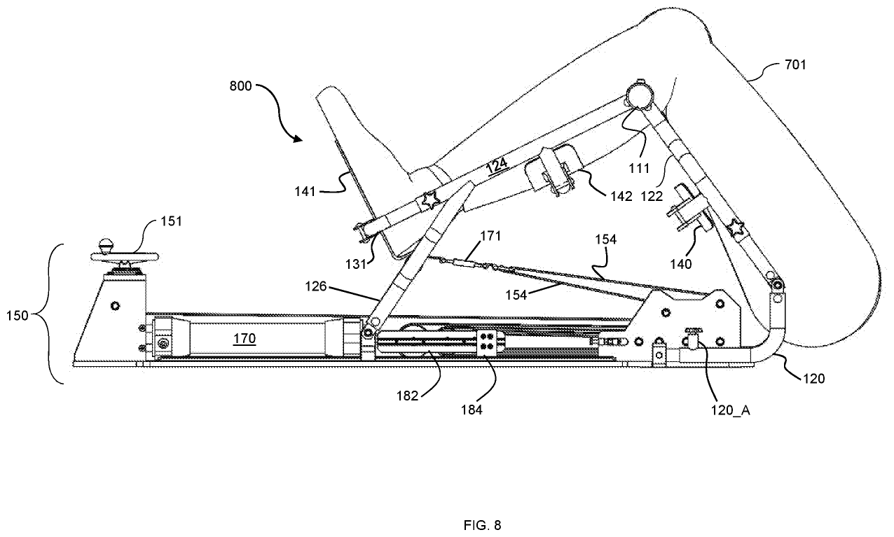

Next, referring to FIG. 8 which illustrates the operation of knee CPM 100 when the user's knee is flexed at an angle. Crank wheel 151 is rotated in a direction that pulls first cable 154 toward manual mode structure 150. Thus, leg frame assembly LFA is pulled away from manual mode structure 150 toward pulley system 190. More particularly, eighth segment 126 with square C shaped connector 126_G and ninth segment 127 with square C shaped connector 127_G slides along the length of first track 102 and second track 103 respectively toward user 701 and away from manual mode structure 150.

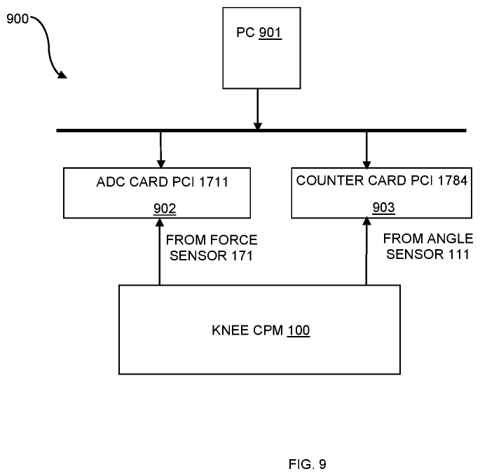

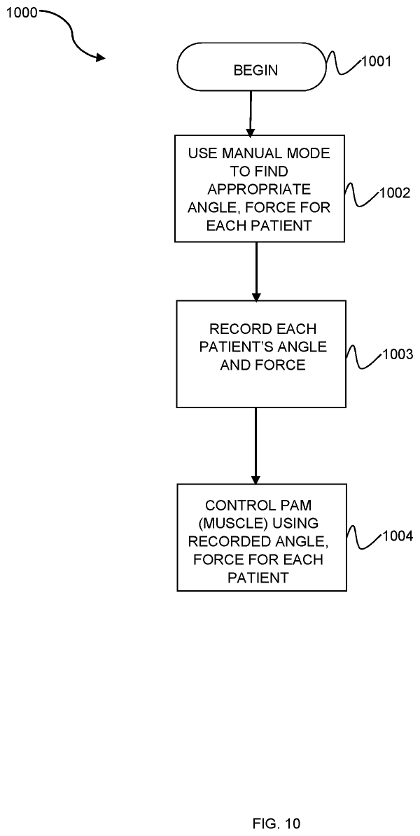

Referring now to FIG. 9 which illustrates system 900 in which knee CPM 100 is connected to multifunction card 902 and a counter 903, both controlled by a PC 901. More particularly, angle sensor 111 is connected to counter 903 and force sensor 171 is connected to multifunction card 902. In one embodiment, multifunction card 902 is an Avantech's PCI 1711 100 kS/s, 12-bit, 16-channel universal PCI multifunction DAQ card; and counter 903 is an Avantech's PCI 1784, 4-axis quadrature encoder and counter card. The operation of knee CPM 100 is described in details in FIG. 10 below.

Now referring to FIG. 10, a method 1000 for operating knee CPM 100 described above is illustrated. Basically, a manual mode is used first to find the comfortable force and angle for each user. After a particular set of force and angle is found for a particular user, the angle and force information are recorded in a memory and then used by a controller such as a computer to control operation of knee CPM 100.

The operation of knee CPM 100 is begun at step 1001. That is, a user places his or her leg on knee CPM 100 as shown in FIG. 7. Then, the length of knee CPM 100 is adjusted to fit the leg of the user by changing the lengths of first segment 120, second segment 121, third segment 122, fourth segment 123, fifth segment 124, sixth segment 125, and seventh segment 131.

Next, at step 1002, a manual mode is used to find comfortable angle and force information for each user. Step 1002 is realized by manual mode assembly 150 as described above. After the user adjusts the length of knee CPM 100, crank wheel 151 is turned until the user start to feel pains or uncomfortable. More particularly, in the stretched position as shown in FIG. 7, when crank wheel 151 is started to turn by an assistant/nurse, first cable 154 is stretched, pulling at force sensor 171. At that moment, first square C shaped connector 125_G and second square C shaped connector 126_G glide along the length of first track 102 and second track 103 respectively. This causes LFA to be flexed at the knee axis at third joint 124_J and fourth joint 125_J. As crank wheel 151 continues to turn, the angle recorded by angle sensor 111 becomes more and more obtuse until user 701 feels pains. At this moment, angle sensor 111 records the angle; force sensor 171 records the tension of first cable 154 where patient 701 can tolerate.

Next, step 1003, the particular set of angle and force information found in step 1002 is stored in a memory of PC 901. Step 1003 is realized by the system 900 as illustrated in FIG. 9. At this stage, a force and angle information of knee CPM 100 for each user are realized and recorded. The force information is sensed by force sensor 171 and communicated to PC 901 via multifunction card 902. The angle information is sensed by angle sensor 111 and communicated to PC 901 via counter 903.

Finally, at step 1004, angle and force information is used by a controller to control the pneumatic artificial muscle (PAM) to rehabilitate the injured knee of user 701 at the optimal level without causing more injuries to the user. Step 1004 is also realized by system 900 as discussed in FIG. 9. Specifically, PC 901 controls PAM 170 which causes LFA to move at a range according to each user's force and angle information. More particularly, PAM 170 is controlled by PC 901 to pull and cause at first frame 181 and second frame 182 to slide a long first connector 183 and second connector 184. This, in turn, causes pulley system 190 to pull second cable 155 and thus causes LFA to flex at the recorded force and angle information.

The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should therefore be construed in accordance with the appended claims and any equivalents thereof.

1. A knee continuous passive machine (CPM), comprising:
a base having a left side, a right side, a front side, and a back side;
a first track and a second track provided along the left side and the right side of said base respectively;
a foldable leg frame assembly having a hind portion and a front portion, the bottom side of said hind portion being fixedly connected to the back side of said base and the bottom side of said front portion slidably coupled to said first track and said second track respectively, configured to fold the top sides of said front portion and said hind portion at an angle proportional to the distance as said front portion slides along the length of said first track and said second track;
a first system of pulleys located on the front side of said base between said first track and said second track;
a second system of pulleys aligned in a straight line with said first system of pulleys, wherein said first system of pulleys is connected to said second system of pulleys and said foldable leg frame assembly by a first cable;
a pneumatic artificial muscle (PAM) motor, connected to said first system of pulleys and said second system of pulleys, operable to cause said front portion of said foldable leg frame assembly to move along said first track and said second track;
a manual mode assembly, connected to said foldable leg frame assembly by a second cable, operable to move said foldable leg frame assembly without affecting the operation of said PAM motor and said first system of pulleys and said second system of pulleys;
an angle sensor, connected to said foldable leg frame assembly, operable to sense said angle formed between the top sides of said front portion and said hind portion of said foldable leg frame assembly as said front portion moves along said first track and said second track; and
a force sensor, connected to said PAM motor, operable to sense a force required for said PAM motor to pull said foldable leg frame assembly to be folded at a particular angle.

2. The knee continuous passive machine (CPM) of claim 1 further comprising a controller, a memory, an angle reader, and a force reader all electrically coupled to said angle sensor and said force sensor.

3. The knee continuous passive machine (CPM) of claim 1 wherein said angle formed between the top sides of said front portion and said hind portion of said foldable leg frame assembly varies from 5 degrees to 120 degrees.

4. The knee continuous passive machine (CPM) of claim 1 wherein said hind portion of said foldable leg frame further comprises:
a left hind portion fixedly connected to a first top left side of said base;
a right hind portion fixedly connected to a second top right side of said base;
wherein said front portion further comprises a left front portion hingedly connected to said left hind portion to form a first rotatable joint;
a right front portion hingedly connected to said right hind portion to form a second rotatable joint;
a fifth segment hingedly connected to said left front portion to form a first adjustable joint;
a sixth segment hingedly connected to said left hind portion to form a second adjustable joint, wherein the axis connecting said said first adjustable joint and said second adjustable joint is the same as the length of said base and wherein said foldable leg frame assembly is configured to bend at said first rotatable joint and said second rotatable joint at said angle;
a seventh segment adjustably connected to both said fifth segment and to said sixth segment;
a thigh rest fixedly connected perpendicular to said left front portion and said left hind portion;
a calf rest fixedly connected perpendicular to said fifth and said sixth segment;
a foot rest connected to the front of said seventh segment;
an eighth segment fixedly connected to said sixth segment;
a ninth segment fixedly connected to said seventh segment, wherein said eighth segment and ninth segment are slidably coupled to said first track and said second track so as front portion slides along the length of said first track and said second track.

5. The knee continuous passive machine (CPM) of claim 2 wherein said thigh rest further comprises a rectangular plate bent downward to said base creating a curve shape so as to support a thigh of a user; and wherein said thigh rest is connected perpendicular to said left front portion and said right front portion by a first bar and a second bar.

6. The knee continuous passive machine (CPM) of claim 2 wherein said calf rest further comprises a second rectangular plate bent downward to said base forming a curve so as to support a calf of a user; and wherein said calf rest is connected perpendicular to said firth segment and said sixth segment by a third bar and a fourth bar.

7. The knee continuous passive machine (CPM) of claim 2 wherein said foot rest is a rectangular plate.

8. The knee continuous passive machine (CPM) of claim 4 wherein said left hind portion, said right hind portion, said right front portion, and said left front portion all comprise telescoping tubes whose lengths are changeable at said first adjustable joint and said second adjustable joint by a clevis pins locking mechanism.

9. The knee continuous passive machine (CPM) of claim 2 wherein the top front of said eighth segment comprises a square C-shaped connector coupled to slide on said first tract, and wherein the top front of said ninth segment comprises a second square C-shaped connector coupled to slide on said second track.

10. The knee continuous passive machine (CPM) of claim 2 wherein the length of said seventh segment is adjustable by a clevis pin locking mechanism.

11. The knee continuous passive machine (CPM) of claim 1 wherein said first system of pulleys further comprises a first pulley, a second pulley, a third pulley, and a fourth pulley arranged in series in a straight line with a decrease in size.

12. The knee continuous passive machine (CPM) of claim 1 wherein said second system of pulleys further comprises a fifth pulley, a sixth pulley, a seventh pulley, and an eighth pulley arranged in series in a straight line with an increase in size, wherein said first cable starts from said first system of pulleys wrapping around said first pulley, said second pulley, said third pulley, said fourth pulley, said fifth pulley, said sixth pulley, said seventh pulley, and said eighth pulley and wherein said first cable is connected to said foldable leg frame assembly via a ninth pulley so that the distance of movement of said foldable leg frame assembly is modified.

13. The knee continuous passive machine (CPM) of claim 1 wherein said manual mode section further comprises a wheel connected to a worm screw and to a tenth pulley, wherein said second cable is connected between said tenth pulley and an eleventh pulley located in said second system of pulleys.

14. A method of rehabilitating a knee using a knee continuous passive machine (CPM) having a base, a foldable leg frame assembly, a manual mode assembly, a pneumatic artificial muscle (PAM) motor, a system of pulleys, a force sensor, and an angle sensor, said method comprising:
using said manual mode assembly to find a force and an angle for a user by adjusting the lengths of said foldable leg frame assembly to fit the length of the leg of said user and by using said manual mode assembly;
recording said force and said angle for said user using said force sensor and said angle sensor respectively; and
controlling said pneumatic artificial muscle (PAM) using said angle and said force for said user.

15. The method of claim 17 wherein said using a manual mode to find a said force and an angle for each patient further comprises adjusting the lengths of said foldable leg frame assembly to fit the length of the leg of said each user.

16. The method of claim 14 wherein said controlling a pneumatic artificial muscle (PAM) using said angle and said force for said each user to rehabilitate said knee further comprises using a controller, a memory, and input/output section coupled to an angle reader and a force reader.

17. The method of claim 14 wherein: said base having a left side, a right side, a front side, and a back side;
a first track and a second track located along the left side and the right side of said base respectively;
said foldable leg frame assembly having a hind portion and a front portion, the bottom side of said hind portion being fixedly connected to the back side of said base and the bottom side of said front portion slidably coupled to said first track and said second track respectively, configured to fold the top sides of said front portion and said hind portion at an angle proportional to the distance as said front portion slides forward and backward along the length of said first track and said second track;
said system of pulleys further comprises: a first system of pulleys located on the front side of said base between said first track and said second track; and a second system of pulleys aligned in a straight line with said first system of pulleys, wherein said first system of pulleys is connected to said second system of pulleys and said foldable leg frame assembly by a first cable;
said pneumatic artificial muscle (PAM) motor, connected to said first system of pulleys and said second system of pulleys, operable to cause said front portion of said foldable leg frame assembly to move along said first track and said second track;
said manual mode assembly, connected to said foldable leg frame assembly by a second cable, operable to move said foldable leg frame assembly without affecting the operation of said PAM motor and said first system of pulleys and said second system of pulleys;
said angle sensor, connected to said foldable leg frame assembly, operable to sense said angle formed between the top sides of said front portion and said hind portion of said foldable leg frame assembly as said foldable leg frame assembly moves along said first track and said second track; and
said force sensor, connected to said PAM motor, operable to sense a force required for said PAM motor to pull said foldable leg frame assembly to be folded at a particular said angle.

18. The method of claim 14 wherein said angle formed between the top sides of said front portion and said hind portion of said foldable leg frame assembly varies from 5 degrees to 120 degrees.

19. The method of claim 14 wherein said foldable leg frame further comprises:
a left hind portion fixedly connected to a first top left side of said base;
a right hind portion fixedly connected to a second top right side of said base;
wherein said front portion further comprises a left front portion hingedly connected to said left hind portion to form a first rotatable joint;
a right front portion hingedly connected to said right hind portion to form a second rotatable joint;
a fifth segment hingedly connected to said left front portion to form a first adjustable joint;
a sixth segment hingedly connected to said left hind portion to form a second adjustable joint, wherein the axis of connecting said said first adjustable joint and said second adjustable joint is the same as the length of said base and wherein said foldable leg frame assembly is configured to bend at said first rotatable joint and said second rotatable joint at said angle;
a seventh segment adjustably connected to both said fifth segment and to said sixth segment;
a thigh rest fixedly connected perpendicular to said left front portion and said;
a calf rest fixedly connected perpendicular to said fifth and said sixth segment;
a foot rest connected to the front of said seventh segment;
an eighth segment fixedly connected to said sixth segment;
a ninth segment fixedly connected to said seventh segment, wherein said eighth segment and ninth segment are slidably coupled to said first track and said second track so as said continuous passive machine slides along the length of said first track and said second track.

20. The method of claim 19 wherein said first segment, said second segment, said left front portion, said right front portion, said fifth segment, said sixth segment, and said seventh segment all comprises telescoping tubes whose lengths are changeable by a clevis pin locking mechanism.

21. The method of claim 20 wherein said first adjusting the lengths of said foldable leg frame assembly to fit the length of the leg of said user further comprises adjusting the lengths of first segment, said second segment, said left front portion, said right front portion, said fifth segment, said sixth segment, and said seventh segment using said clevis pin locking mechanism.
